(19) United States
(12) Patent Application Publication
(10) Pub. No.: US 2008/0269916 A1
(43) Pub. Date: Oct. 30, 2008

(54) Hardware Component Management Using Visual Graphics

(76) Inventors: Christopher G. Malone, Loomis, CA (US); Thane M. Larson, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/741,511

(22) Filed: Apr. 27, 2007

(51) Int. Cl. G05B 11/01

(52) U.S. Cl. 700/17

(57) ABSTRACT

A management system includes a management application that is executable in a central management station and is operative to manage hardware components one or more systems using visual graphics that presents assembly and repair functionality in combination with system health information. The management application is further operative to present a visual set of step-by-step instructions through the visual graphics for addition, deletion, and/or replacement of the managed hardware components.

### BACKGROUND

Data center personnel face a growing challenge in managing multiple servers and other information technology equipment in a large data center. Multiple aspects of operation include partitions, performance, environmental measurements, and failure data which are analyzed in combination as measures of relative health of the servers.

Typical techniques for modifying a hardware configuration in a computing or electronic system are initiated from a tool in the operating system or involve physical procedures such as pulling a switch, waiting for a signal (LED) indicating permission to proceed, and physically inserting, removing, or replacing the hardware component. Both operating system tools and physical procedures assume a priori knowledge of the system under operation and are typically not trusted by users or customers. A common fear is that user error will cause a system crash.

### SUMMARY

An embodiment of a management system includes a management application that is executable in a central management station and is operative to manage hardware components one or more systems using visual graphics that presents assembly and repair functionality in combination with system health information. The management application is further operative to present a visual set of step-by-step instructions through the visual graphics for addition, deletion, and/or replacement of the managed hardware components.

### BRIEF DESCRIPTION OF THE DRAWINGS

Embodiments of the invention relating to both structure and method of operation may best be understood by referring to the following description and accompanying drawings:

FIG. 1 is a schematic block and circuit diagram depicting an embodiment of a system that enables hardware component management using visual graphics;

FIGS. 2A through 2E, multiple flow charts illustrate one or more embodiments or aspects of a method for hardware component management using visual graphics; and

FIGS. 3A and 3B are schematic pictorial diagrams illustrating examples of a display that can be generated by the illustrative management system according to the disclosed methods and techniques.

### DETAILED DESCRIPTION

A visual troubleshooting and diagnostic tool enables online management of add, subtract or delete, and/or replacement of hardware components. Accordingly, the visual troubleshooting and diagnostic repair tool can be used to initiate replacement and indicate input/output (I/O) card status.

Typically tools that implement online add/delete/replace functionality of components such as I/O cards and cells run under direction of an operating system and are limited by operator rights of a system. However, repair procedures and operations of modifying resources in the system are better associated with operations of an information technology (IT) administrator. The illustrative visual troubleshooting and diagnostic tool operates as an IT administrator application that enables a visual set of step-by-step procedures for troubleshooting, replacing, and exchanging hardware in the system. The functionality of online add/delete/replace (OL*) operations is better suited to an IT administrator application such as the disclosed visual troubleshooting and diagnostic tool rather than a process that resides on the operating system since control of hardware resources is thus placed in the domain of operators most capable and appropriate for hardware management.

An illustrative visual troubleshooting and diagnostic tool enables step by step instructions through a pictorial display for the replacement of hardware in a system. Furthermore, the visual troubleshooting and diagnostic tool has linkages to the system under repair and/or replace procedures to tailor steps to a particular procedure.

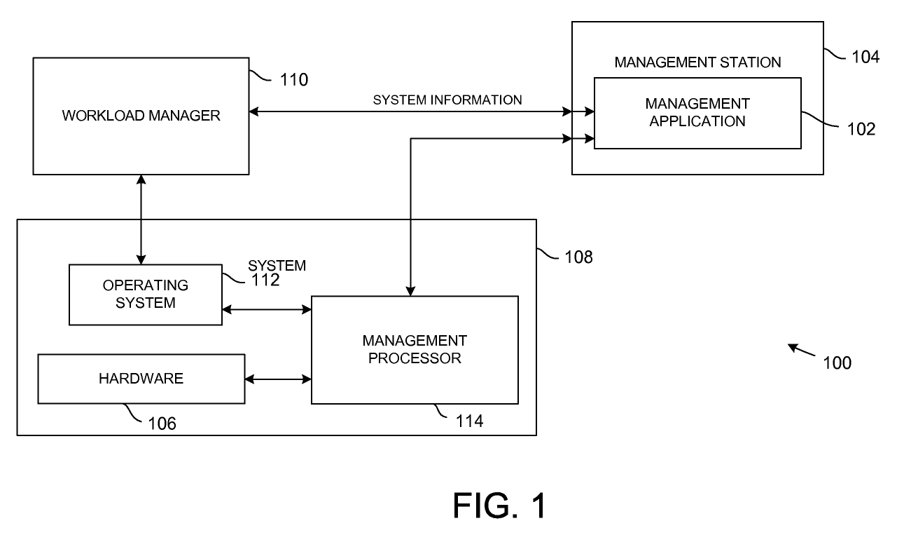

Referring to FIG. 1, a schematic block and circuit diagram depicts an embodiment of a management system 100 that enables hardware component management using visual graphics. The illustrative management system 100 comprises a management application 102 that is executable in a central management station 104 and operates to manage hardware components 106 in one or more systems 108 using visual graphics that present assembly and repair functionality in combination with system health information. The management application 102 further operates to present a visual set of step-by-step instructions through the visual graphics for addition, deletion, and/or replacement of the managed hardware components 106.

In an example implementation, the visual troubleshooting and diagnostic tool displays a pictorial view of a system 108, for example with color coding, which illustrates the specific components in the system 108 along with operational information.

In the illustrative implementation, the management system 100 can further comprise the central management station 104 which is operative for executing the management application 102 and one or more workload managers 110 that are communicatively coupled to the central management station 104 and operate in combination with the central management station 104 to communicate system information. The managed systems 108 generally comprise an operating system 112, one or more hardware components 106, and a management processor 114. The management application 102 controls management of hardware components 106 at the central management level by online actions.

The management application 102 can determine status of hardware components 106 at the central management level by online actions, for example by selectively adding, deleting, and/or replacing hardware components 106 by online actions based on status.

The management application 102 forms part of a user interface that presents a visual set of step-by-step instructions to a user that enable addition, deletion, and/or replacement by forming a pictorial representation of the managed hardware components 106.

The management application 102 enables graphical, system-level views that combine the physical details of a system 108 with error and environment management information, facilitating assessment of the root cause of system failures. For example, room temperature can vary over time, causing the system to overheat and generate processor parity errors. The illustrative management application 102 can be used to assist replacement of hardware components 106 in light of environmental considerations such as temperature.

In an example embodiment, the management application 102 can be used to access information relating to environmental conditions, error status, physical details, and/or management information which are determined by the management processor 114 internal to the system 108. The management application 102 pictorially displays the accessed environmental conditions, error status, physical details, and/or management information. The management application 102 also presents or displays the visual set of step-by-step instructions through the visual graphics to enable the addition, deletion, and/or replacement of the managed hardware components 106 according to an instruction set that is specific to the respective environmental conditions, error status, physical details, and/or management information of the monitored system 108.

Examples of environmental conditions, error status, physical details, and/or management information that are accessed by the management application 102 include, but are not limited to, field replaceable unit (FRU) loading, thermal data, temperature data, air flow data, power consumption, and/or error conditions.

FRU loading, thermal data including temperature and air flow, power consumption, and errors are examples of accessible records that visual troubleshooting and diagnostic tool can display in layers.

Thus the illustrative management system 100 combines a visual tool for assembly and repair with depiction of system health information.

The management application 102 can perform many operations including online addition, deletion, and/or replacement of hardware components 106 and accessing information from a selected target system using a handshake interaction. The management application 102 can then display a pictorial slide show of steps for performing the online addition, deletion, and/or replacement operations which specify particular actions to perform and particular times and/or conditions to perform the actions.

In an example operation for pictorially representing the managed hardware components, the management application 102 can overlay selected measured and recorded data that is acquired from manageability tools onto a topographic, scalable, graphic image of selected managed hardware components. The management application 102 also enables a user to selectively zoom, pan, and/or view a selected physical representation of the managed hardware components in a graphic image. The graphic image can be displayed online or as a standalone utility.

In some implementations or in some conditions, the management application 102 can also enable a user to selectively rotate, disassemble into subassembly, and/or zoom in or out the displayed graphic image.

In some further embodiments, the management application 102 can pictorially represent the managed hardware components 106 by enabling a user to acquire measured data and a priori known information from manageability tools and construct modeled data from the acquired measured data and a priori known information, then visually displaying the modeled data.

The management system 100 can be used in combination with provisioning tools such as a workload manager for visual performance monitoring at the FRU and system level, enabling a user to identify inter-component bottlenecks and interactive management of load balancing for usage in adding, deleting, and/or replacing hardware components 106.

The add/delete/replace (OL*) functionality can be used in combination with tools for performance monitoring, workload balancing, and application partitioning of dynamic processes. Data acquired from memory, I/O, and processor sources can be used to determine interconnect performance and represented visually to enable improved tuning of the system. For example, adding memory can be indicated to improve performance when dual in-line memory modules (DIMMs) are overloaded while busses to the DIMMs are not.

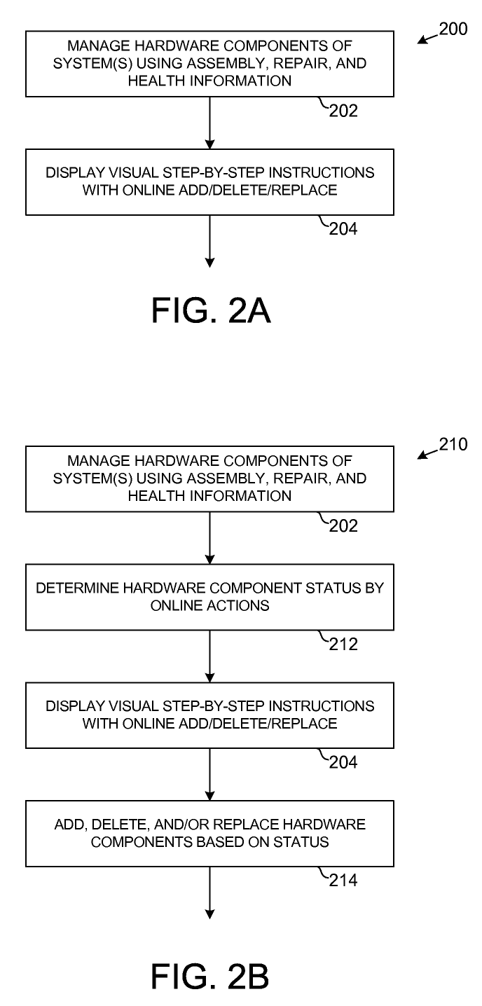

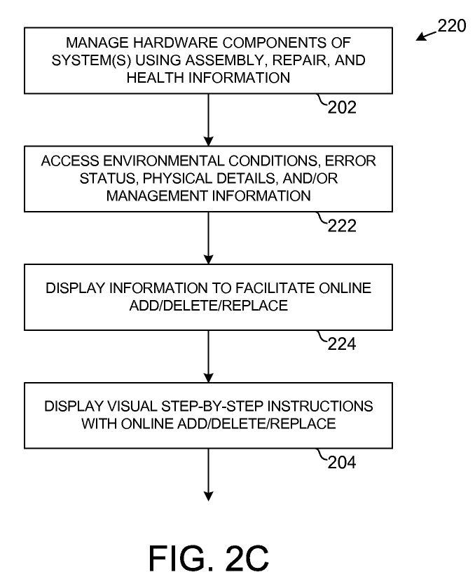

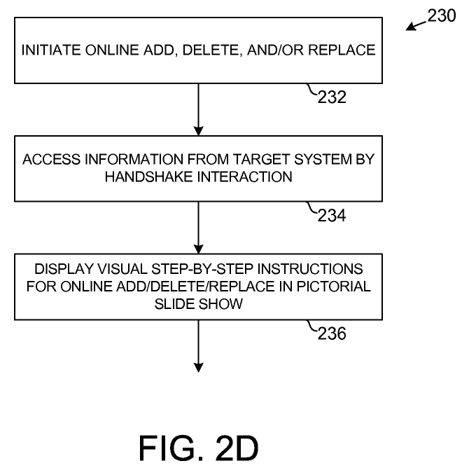

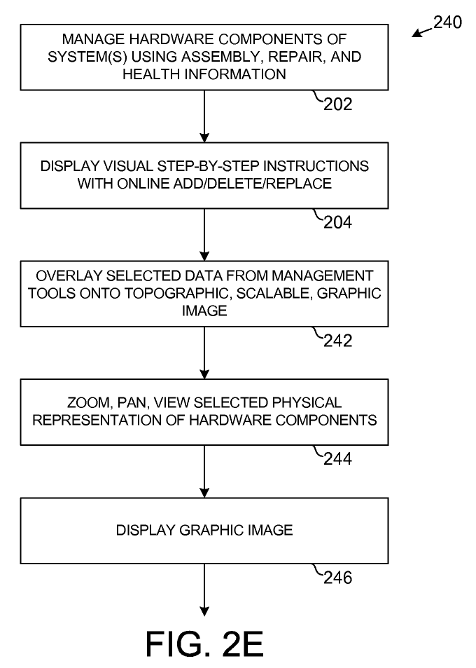

Referring to FIGS. 2A through 2E, multiple flow charts illustrate one or more embodiments or aspects of a method for hardware component management using visual graphics. In an example implementation, a user starts an online add/delete/replace (OL*) operation, handshakes with the system, and presents to the user a “slide show” of steps to facilitate performance of appropriate and correct actions, at the appropriate time for performing the actions.

FIG. 2A illustrates an embodiment of a method 200 for managing hardware components comprising managing 202 hardware components in one or more systems at a central management level using visual graphics that present assembly and repair functionality in combination with system health information. A visual set of step-by-step instructions are presented or displayed 204 through the visual graphics for addition, deletion, and/or replacement of the managed hardware components.

For example, the visual set of step-by-step instructions can be presented 204 for addition, deletion, and/or replacement by a pictorial representation of the managed hardware components.

Management of hardware components can be controlled at the central management level by online actions.

Referring to FIG. 2B, in a particular embodiment of a management method 210 the status of hardware components at the central management level can be determined 212 by online actions and hardware components are selectively added, deleted, and/or replaced 214 by online actions based on the status.

Referring to FIG. 2C, in some embodiments of a management method 220 the information such as environmental conditions, error status, physical details, and/or management information determined by a management processor internal to the monitored systems can be accessed 222. The accessed environmental conditions, error status, physical details, and/or management information can be pictorially displayed 224 to facilitate addition, deletion, and/or replacement of the managed hardware components.

In an example embodiment, the visual set of step-by-step instructions can be presented 204 through the visual graphics for addition, deletion, and/or replacement of the managed hardware components according to an instruction set that is specific to the accessed environmental conditions, error status, physical details, and/or management information of the at least one system.

Examples of environmental conditions, error status, physical details, and/or management information that can be accessed include field replaceable unit (FRU) loading, thermal data, temperature data, air flow data, power consumption, and/or error conditions.

Referring to FIG. 2D, in an example embodiment of a hardware component management method 230 an online addition, deletion, and/or replacement operation can be initiated 232 and information accessed 234 from a selected target system using a handshake interaction. A pictorial slide show of steps is displayed 236 for performing the online addition, deletion, and/or replacement operation specifying specific actions to perform and specific times and/or conditions to perform the actions.

Referring to FIG. 2E, in a particular embodiment of a management method 240 the managed hardware components can be pictorially represented by overlaying 242 selected measured and recorded data acquired from manageability tools onto a topographic, scalable, graphic image of selected managed hardware components. A user can selectively zoom, pan, and/or view 244 a selected physical representation of the managed hardware components in a graphic image and display 246 the graphic image online or as a standalone utility.

In some implementations, a user can be enabled to selectively rotate, disassemble a structure into one or more subassemblies, and/or zoom in or out the displayed graphic image.

The illustrative system and operating methods reduce the amount of user error in performing the online add/delete/replace (OL*) operation. Visual pictorial display of steps, at the time the steps are to be performed, enable an inexperienced user or technician to precisely perform correct operations, rather than relying on a priori knowledge and voluminous documentation.

Computing power can be used to present information visually to enable discoveries in diverse fields including medical imaging and scientific modeling in physics, chemistry, and biology. Visualization conveys a tremendous amount of information at one time, enabling the user to make rapid connections and interpretations. The illustrative visual troubleshooting and diagnostic tool enables the power of visualization to be applied to management of the servers.

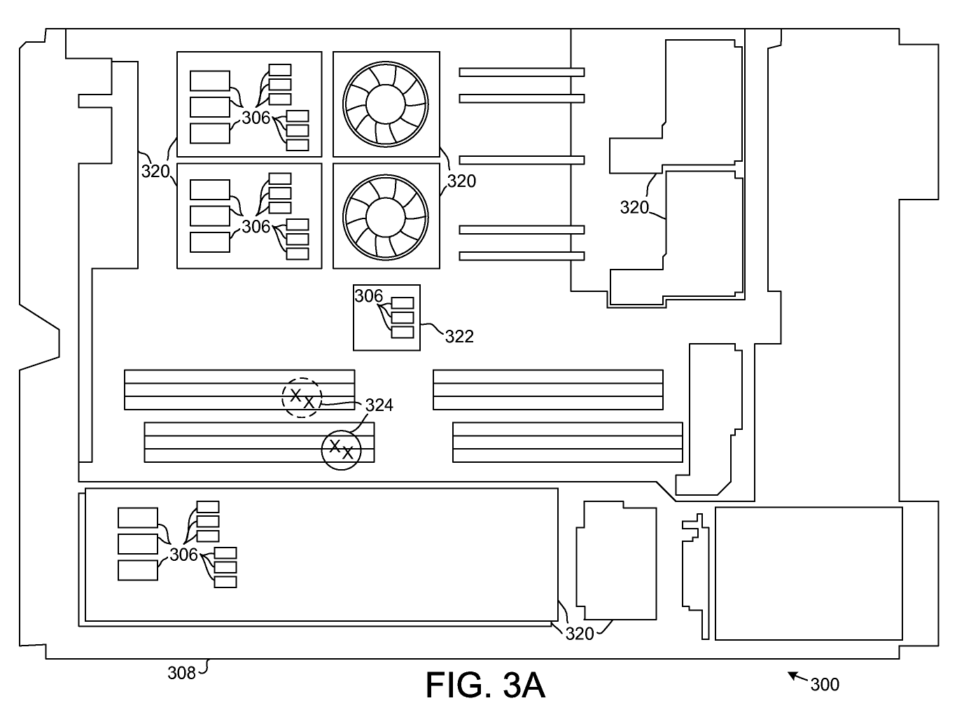

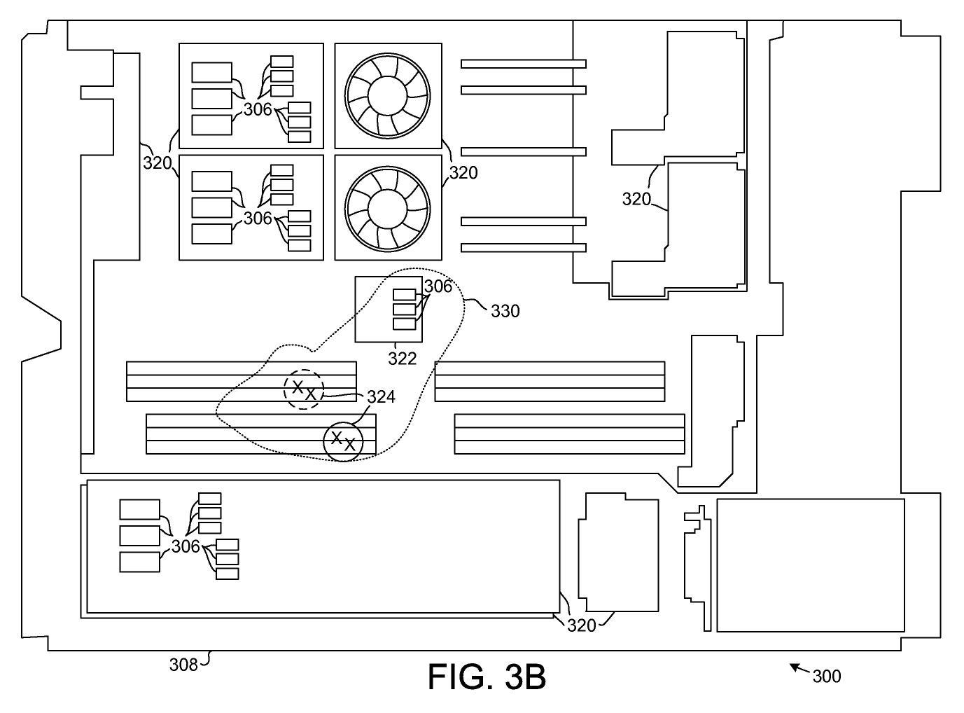

Referring to FIG. 3A, a schematic pictorial diagram illustrates an example of a display that can be generated by the illustrative management system according to the disclosed methods and techniques. A system 308 is shown including multiple hardware components 306. A display 300 shows loaded field replaceable units (FRUs) 320. Conditions such as uncorrectable errors 324 can also be indicated, as well as disabled FRUs 322. Real time information can be integrated into the display 300 that is acquired from devices such as temperature or other sensors. In various applications, corrected and uncorrected errors, correlation to system event logs, live display states such as are typically indicated by light-emitting diodes (LEDs), along with interactive troubleshooting information using server data. Data can be animated over time.

The illustrative visual troubleshooting and diagnostic tool can operate in accordance with a concept of overlaying various results which are measured and recorded by manageability tools onto a topographic, scalable, graphic image of a server or system. The scalable graphical image enables a user to zoom, pan, and view from various angles a physical representation of the server. The graphical image can be viewed over a web page or as a stand-alone utility. A topographic-like map of the parameters is overlaid on the image of the server. Parameters can be individually or collectively viewed. The visual representation of the parameters can be shown as absolute, relative, or as importance maps.

The visual troubleshooting and diagnostic tool enables display of environmental conditions and error states of a computer system over time, for example temperature changes and component errors, enabling complex cause and effect relationships to be more easily determined from the data.

Referring to FIG. 3B, a schematic pictorial view shows an example of a display 300 that includes interpolated temperature and performance mapping. The display 300 shows discrete temperature sensor data in a visual presentation, for example depicting temperature field information extrapolated from sensor data. Information can be enhanced with modeled data fit to the live sensor data, resulting in a suitable estimate of a temperature map inside the system without using additional sensors. Similarly, system airflow patterns can be displayed using sensed fan speed information. Errors or other variables can be displayed in a similar fashion.

Various embodiments can display performance information, capacity on demand data. In some embodiments, the system can access information from provisioning tools such as workload management tools.

For example, a parameter such as temperature 330 can be represented as a rainbow of hues from red to blue representing absolute temperatures in the box. Thus a hot component is shown with a higher temperature than a cool component.

In other embodiments, conditions, or applications, a relative view can be used. A component can be shown with characteristics compared to baseline values. For example, although component A may be hotter than component B, component A may be in specification and B not in compliance. Thus, component A is shown with a “cool” color and component B with a “hot” color.

In still other examples, a parameter can be compared to ranges of importance and can thus be flagged according to OK, Warning, or Critical conditions with three colors to represent different cases.

The different display view types can be used as appropriate according to application and can be combined and/or matched for various parameters tracked in a system.

The visual troubleshooting and diagnostic tool enables rapid production and display of meaningful data that can be acted on by pointing to a physical spot in the box. The visual troubleshooting and diagnostic tool thus can reduce overhead, and usage of labels, manuals, and foreknowledge of the system.

In an example embodiment, the visual troubleshooting and diagnostic tool can be implemented by a framework of graphical presentation tools using Macromedia FLASH to present physical views of a system along with an assembly process. In another example, the visual troubleshooting and diagnostic tool can be constructed using the emerging standard of AJAX (Asynchronous Javascript technology And XML) as a basis. The FLASH-based framework enables display of a system with either bit-mapped or vector-mapped graphic images, allowing for animation, and permitting overlays of multiple images. Product images can be rotated, disassembled into subassemblies, and magnified for close inspection (zoom in/out). Animation can be added for some processes, and content can be hyperlinked to an online troubleshooting guide.

Terms “substantially”, “essentially”, or “approximately”, that may be used herein, relate to an industry-accepted tolerance to the corresponding term. Such an industry-accepted tolerance ranges from less than one percent to twenty percent and corresponds to, but is not limited to, functionality, values, process variations, sizes, operating speeds, and the like. The term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. Inferred coupling, for example where one element is coupled to another element by inference, includes direct and indirect coupling between two elements in the same manner as “coupled”.

The illustrative block diagrams and flow charts depict process steps or blocks that may represent modules, segments, or portions of code that include one or more executable instructions for implementing specific logical functions or steps in the process. Although the particular examples illustrate specific process steps or acts, many alternative implementations are possible and commonly made by simple design choice. Acts and steps may be executed in different order from the specific description herein, based on considerations of function, purpose, conformance to standard, legacy structure, and the like.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims.

What is claimed is:

1. A method for managing hardware components comprising:
managing hardware components in at least one system at a central management level using visual graphics that present assembly and repair functionality in combination with system health information; and
presenting a visual set of step-by-step instructions through the visual graphics for addition, deletion, and/or replacement of the managed hardware components.

2. The method according to claim 1 further comprising:
controlling management of hardware components at the central management level by online actions.

3. The method according to claim 1 further comprising:
determining status of hardware components at the central management level by online actions; and
selectively adding, deleting, and/or replacing hardware components by online actions based on the status.

4. The method according to claim 1 further comprising:
presenting the visual set of step-by-step instructions for addition, deletion, and/or replacement by pictorial representation of the managed hardware components.

5. The method according to claim 1 further comprising:
accessing environmental conditions, error status, physical details, and/or management information determined by a management processor internal to the at least one system; and
pictorially displaying the accessed environmental conditions, error status, physical details, and/or management information.

6. The method according to claim 1 further comprising:
accessing environmental conditions, error status, physical details, and/or management information determined by a management processor internal to the at least one system; and
presenting the visual set of step-by-step instructions through the visual graphics for addition, deletion, and/or replacement of the managed hardware components according to an instruction set that is specific to the accessed environmental conditions, error status, physical details, and/or management information of the at least one system.

7. The method according to claim 1 further comprising:
accessing environmental conditions, error status, physical details, and/or management information comprising field replaceable unit (FRU) loading, thermal data, temperature data, air flow data, power consumption, and/or error conditions.

8. The method according to claim 1 further comprising:
initiating an online addition, deletion, and/or replacement operation;
accessing information from a selected target system of the at least one system using a handshake interaction; and
displaying a pictorial slide show of steps for performing the online addition, deletion, and/or replacement operation specifying specific actions to perform and specific times and/or conditions to perform the actions.

9. The method according to claim 1 further comprising:
pictorially representing the managed hardware components comprising:
overlaying selected measured and recorded data acquired from manageability tools onto a topographic, scalable, graphic image of selected managed hardware components;
selectively zooming, panning, and/or viewing a selected physical representation of the managed hardware components in a graphic image; and
displaying the graphic image online or as a standalone utility.

10. The method according to claim 9 further comprising:
selectively rotating, disassembling into subassembly, and/or zooming in or out the displayed graphic image.

11. A management system comprising:
a management application executable in a central management station operative to manage hardware components in at least one system using visual graphics that present assembly and repair functionality in combination with system health information, the management application further operative to present a visual set of step-by-step instructions through the visual graphics for addition, deletion, and/or replacement of the managed hardware components.

12. The management system according to claim 11 further comprising:
the central management station operative for executing the management application;
at least one workload manager communicatively coupled to the central management station and operative in combination with the central management station to intercommunicate system information;
the at least one system comprising an operating system, at least one hardware component, and a management processor; and
the management application operative to control management of hardware components at the central management level by online actions.

13. The management system according to claim 11 further comprising:
the management application operative to determine status of hardware components at the central management level by online actions, and selectively add, delete, and/or replace hardware components by online actions based on the status.

14. The management system according to claim 11 further comprising:
the management application operative to present the visual set of step-by-step instructions for addition, deletion, and/or replacement by pictorial representation of the managed hardware components.

15. The management system according to claim 11 further comprising:
the management application operative to access environmental conditions, error status, physical details, and/or management information determined by a management processor internal to the at least one system; operative to pictorially display the accessed environmental conditions, error status, physical details, and/or management information; and operative to present the visual set of step-by-step instructions through the visual graphics for addition, deletion, and/or replacement of the managed hardware components according to an instruction set that is specific to the accessed environmental conditions, error status, physical details, and/or management information of the at least one system.

16. The management system according to claim 11 further comprising:
the management application operative to access environmental conditions, error status, physical details, and/or management information comprising field replaceable unit (FRU) loading, thermal data, temperature data, air flow data, power consumption, and/or error conditions.

17. The management system according to claim 11 further comprising:
the management application operative to initiate an online addition, deletion, and/or replacement operation; access information from a selected target system of the at least one system using a handshake interaction; and display a pictorial slide show of steps for performing the online addition, deletion, and/or replacement operation designating specific actions to perform and specific times and/or conditions to perform the actions.

18. The management system according to claim 11 further comprising:
the management application operative to pictorially represent the managed hardware components comprising:
overlaying selected measured and recorded data acquired from manageability tools onto a topographic, scalable, graphic image of selected managed hardware components;
selectively zooming, panning, and/or viewing a selected physical representation of the managed hardware components in a graphic image; and
displaying the graphic image online or as a standalone utility.

19. The management system according to claim 18 further comprising:
the management application operative to selectively rotate, disassemble into subassembly, and/or zoom in or out the displayed graphic image.

20. The management system according to claim 11 further comprising:
the management application operative to pictorially represent the managed hardware components comprising:
acquiring measured data and a priori known information from manageability tools;
constructing modeled data from the acquired measured data and a priori known information; and
visually displaying modeled data.

21. An article of manufacture comprising:
a controller usable medium having a computable readable program code embodied therein for managing hardware components, the computable readable program code further comprising:
a code adapted to cause the controller to manage hardware components in at least one system at a central management level using visual graphics that present assembly and repair functionality in combination with system health information; and
a code adapted to cause the controller to present a visual set of step-by-step instructions through the visual graphics for addition, deletion, and/or replacement of the managed hardware components.
